(19) United States
(12) Patent Application Publication
(10) Pub. No.: US 2010/0015591 A1
(43) Pub. Date: Jan. 21, 2010

(54) INFORMATION PROCESSING SYSTEM AND INFORMATION GATHERING APPARATUS THEREOF

(75) Inventors: LUNG DAI, Tu-Cheng (TW); ZHI-PENG MA, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/503,861

(22) Filed: Jul. 16, 2009

(30) Foreign Application Priority Data
Jul. 21, 2008 (CN) 200810302869.6

(51) Int. Cl. G09B 7/00

(52) U.S. Cl. 434/358

(57) ABSTRACT

An information gathering apparatus for gathering information from a scannable document including a plurality of information regions includes a plurality of gathering circuits corresponding to the plurality of information regions. Each gathering circuit emits light to the corresponding information region and receives light reflected from the corresponding information to generate electrical signals based on an intensity of reflected light.

### BACKGROUND

1. Technical Field

The present disclosure generally relates to information processing systems, and particularly to an information gathering apparatus for the information processing systems.

2. Description of Related Art

For many years, standardized tests have been administered to examinees for various reasons, such as academic skill tests or evaluating particular skill tests. For example, academic skill tests are typically administered to a large number of students. Results of these tests are used by college, universities, and other educational institutions to determine whether an examinee should be admitted to study at that education institution. Other standardized tests are carried out to determine whether or not an examinee has attained a specified level of knowledge of a given subject.

FIG. 1 shows a question sheet 10 and an answer sheet 20 which might be given on a standardized test. The question sheet 10 provides a plurality of questions, and groups of responses 1, 2, and 3, etc. corresponding to the questions. One question and one group of responses corresponding to that question are referred to as an item. The answer sheet 20 provides groups of responses corresponding to the responses of the questions sheet 10. The examinee is requested to select one of the responses according to the question provided with each item and fill in the appropriate square on the answer sheet 20. For example, the correct answer to the question 1 is (A) of the one corresponding group of the responses. Thus, the examinee's correct response to question 13 is filled in the square 30 as corresponding to choice (A).

Now, the answer sheet shown in FIG. 1 is a scannable document which can be automatically scored by an information processing system. Because an examinee's response to each item is represented on an answer sheet simply by a filled in square, the information processing system can scan the answer sheet by a scanner, and determine the examinee's response to each item by analyzing a scanned image via a computer. The computer can further store the correct response to each item in a database and be programmed to compare the examinee's response with the correct response for each item. After all items have been scored, the computer determines the examinee's overall score for the test.

However, scanning and analyzing the scanned image is time consuming and costly.

Therefore, an information processing system and an information gathering apparatus of saving time and cost is desired.

Other advantages and novel features will become more apparent from the following detailed description of exemplary embodiments when taken in conjunction with the accompanying drawings.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 shows a question sheet and an answer sheet given in a standardized test.

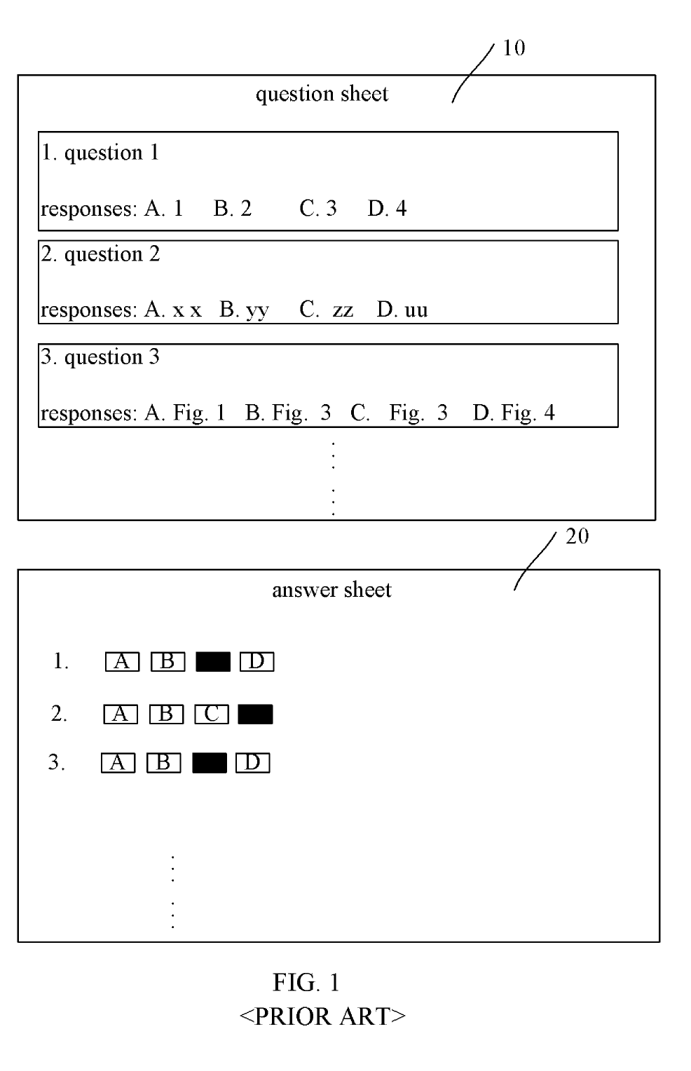

FIG. 2 shows a scannable document in accordance with an exemplary embodiment.

FIG. 3 is a block diagram of an information processing system in accordance with an exemplary embodiment, wherein the information processing system includes an information gathering apparatus.

FIG. 4 is a circuit diagram of the information gathering apparatus of FIG. 3 in accordance with an exemplary embodiment.

### DETAILED DESCRIPTION

References will now be made to the drawings to describe exemplary embodiments of an information gathering apparatus employed in an information processing system.

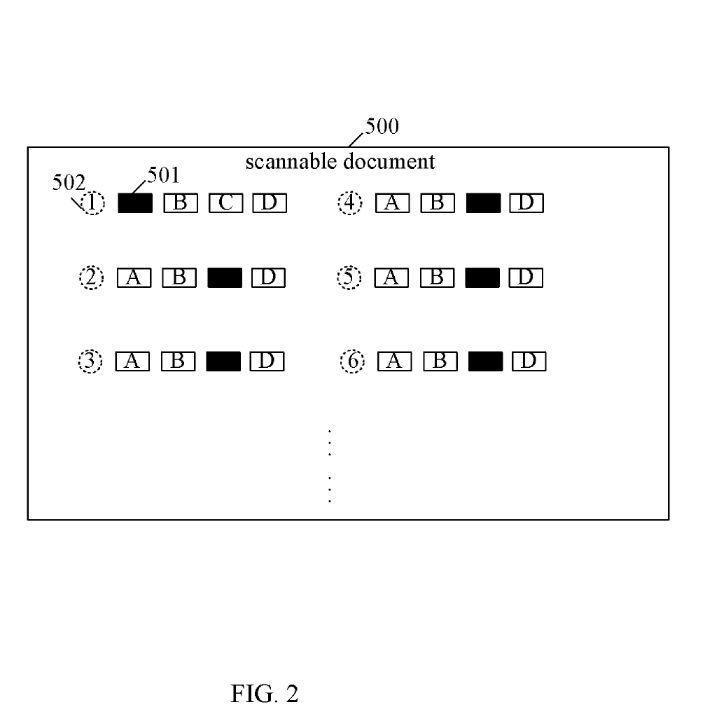

The disclosure provides an information processing system and an information gathering apparatus for gathering and processing information from a scannable document such as an answer sheet or a ballot. As indicated in FIG. 2, a scannable document 500 includes a plurality of information regions 501 arranged in a pre-set format, such as a matrix. The scannable document 500 may have a light background color, and further defining predetermined information regions 501. The predetermined information regions 501 also have a light background color in initial state, and are selectably filled in with a dark color (marked) by a examinee. In one implementation, the dark color may be black. Hereinafter the predetermined information regions 501 marked are described as marked regions and the predetermined information regions 501 unmarked are described as unmarked regions to more clearly describe embodiments of the invention.

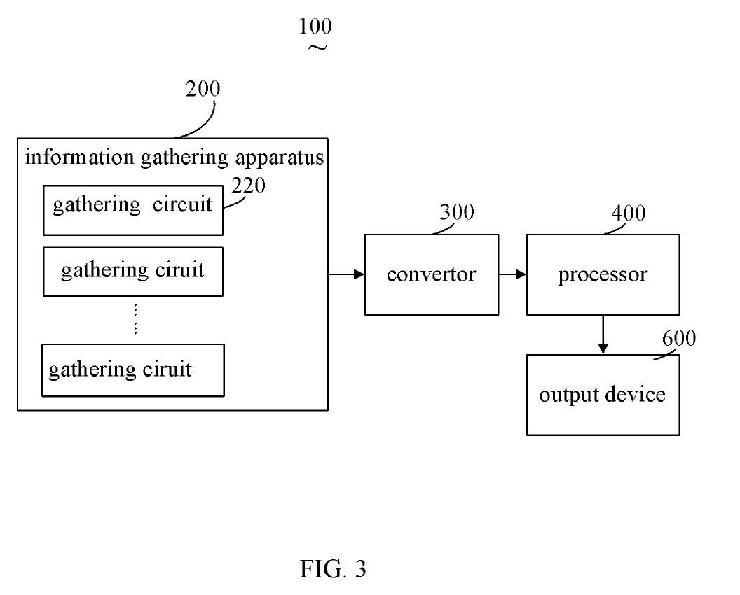

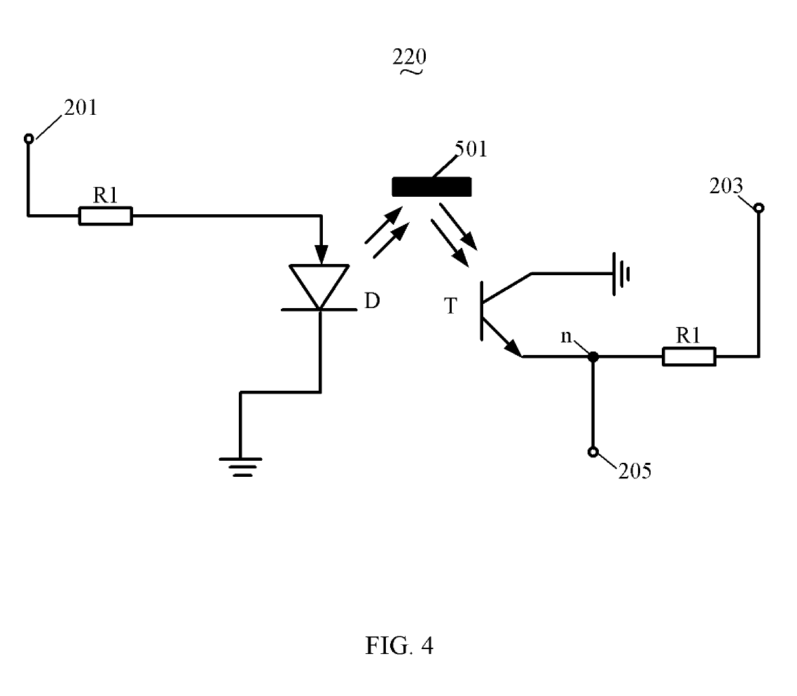

Referring to FIGS. 3 and 4, an information processing system 100 includes an information gathering apparatus 200, a convertor 300, a processor 400, and an output device 600. The information gathering apparatus 200 is electrically coupled to the convertor 300. The convertor 300 is electrically coupled to the processor 400. The processor 400 is electrically coupled to the output device 600. The information gathering apparatus 200 is configured for gathering information from the scannable document 500 by projecting emitted light on the information regions 501 and generating electrical signals based on the reflected light received from the information regions 501. The information gathering apparatus 200 faces the scannable document 500 in a manner such emitted light from the information gathering apparatus 200 projects to the information regions 501. For example, the information gathering apparatus 200 may be placed above or bellow the scannable document 500. The distance between the information gathering apparatus 200 and the scannable document 500 may be 1 millimeter (mm) to 10 mm. The information gathering apparatus 200 includes a plurality of gathering circuits 220 corresponding to the information regions 501. Each gathering circuit 220 is aligned to one information region 501 correspondingly. The gathering circuits 220 are configured for projecting emitted light to the corresponding information regions 501 and receiving reflected light from the information regions 501 corresponding so as to generate electrical signals. For example, if some information regions 501 are marked, emitted light is absorbed by the mark resulting that reflected light from mark having a relatively low intensity. As a result, an intensity of the light reflected from the marked information regions 501 is lower than that of the light reflected from unmarked information regions. Correspondingly, an amplitude of the electrical signals generated corresponding to the marked information regions 501 is lower than that of the un-marked information regions 501. Therefore, marked regions and unmarked regions are identifiable by analyzing the intensity of the light or the amplitude of the electrical signals.

Each gathering circuit 220 includes a first input terminal 201, a second input terminal 203, an output terminal 205, a first resistor R1, a second resistor R2, a light emitting diode D, and a phototransistor T. The anode of the light emitting diode D is electrically coupled to the first input terminal 201 via the first resistor R1, and the cathode is grounded. The collector of the phototransistor T is electrically coupled to the second input terminal 203 via the second resistor R2, The emitter of the phototransistor T is grounded. The first input terminal 201 and the second input terminal 203 are coupled to external power supplies (not shown). A node n is connected between the emitter of the phototransistor T and the second resistor R2. The node n is coupled to the convertor via the output terminal 205.

In operation, when the first input terminal 201 and the second input terminal 203 are powered by the external power supplies, the light emitting diode D emits light to the corresponding information regions 501, and the phototransistor T receives the reflected light from the corresponding information regions 501. When the corresponding regions 501 are marked, emitted light is almost absorbed by the mark, such that the intensity of the reflected light is very low, thus the phototransistor T is turned off. As a result, a high voltage is generated at the node n. The gathering circuits 220 outputs the high voltage (the electrical signals) to the convertor 300 via the output terminal 205. When the corresponding information regions 501 are unmarked, the intensity of the reflected light from the information region is stronger, such that the phototransistor T is turned on. As a result, a low voltage is generated at the node n. The gathering circuits 220 outputs the low voltage (the electrical signals) to the convertor 300.

The convertor 300 receives the electrical signals at high voltage or low voltage and converts the received electrical signals to digital signals. For example, the convertor 300 generates logic “1” when the electrical signal is at high voltage, while generates logic “0” when the received electrical signal is at low voltage.

The processor 400 receives the digital signals and analyses the digital signals applying a predetermined algorithm to generate a viewable result of the information of the scannable document 500 provided that the scannable document 500 in the FIG. 2 is an answer sheet. The circles 502 indicate questions and each question corresponds to four information regions 501 marking with responses A, B, C, D. The responses A, B, C, D are printed for an examinee to selectively fill in to mark as an answer. For example, if the correct answer of the question 1 is response B, the processor 400 stores “0100” as the correct answer in a digital signal format for the question 1. If the response A is selected as the answer to the question 1, the information region 501 of the response A may marked, so the corresponding gathering circuits 220 corresponding to the four information regions generates electrical signals as high voltage, low voltage, low voltage, and low voltage respectively. Secondly, the convertor 400 generates digital signals “1000” corresponding to the electrical signals. Thirdly, the processor 500 receives the digital signals “1000”, compares the received digital signals “1000” with the correct answer “0100”, and generates the viewable result indicating the comparison.

The output device 600 is configured for outputting the result for the examinee. The output device 600 may be a printer or other mark devices for marking the scannable document 500 with the result.

As described above, the information gathering apparatus generates different electrical signals based on the different intensities of the reflected lights from the marked and the non-unmarked information regions. So the information processing system 100 can determine which information regions is marked or unmarked to gathering the information of the answer sheet or the ballot based on the different electrical signals. It is not needed to scan the answer sheet or the ballot to form an image and analyze the image, thus time may be saved. Further, the information processing system 100 uses the emitting diode and the phototransistor of low price instead of a high priced scanner, thus cutting cost.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An information processing system, comprising:
an information gathering apparatus for gathering information from a scannable document, the scannable document comprising a plurality of information regions, the information gathering apparatus comprising a plurality of gathering circuits corresponding to the plurality of information regions, each gathering circuit capable of emitting light, projecting the emitted light to the corresponding information region, and receiving the light reflected from the corresponding information to generate electrical signals based on an intensity of the reflected light;
a convertor for receiving the electrical signals and converting the received electrical signals to digital signals; and
a processor for analyzing the digital signals applying a predetermined algorithm to generate a viewable result of the information of the scannable document.

2. The information processing system of claim 1, wherein the electronic signals includes a high voltage signal and a low voltage signal, the gathering circuit generates one of the high voltage signal and the low voltage when the light reflected from the corresponding information region has a light intensity, and the gathering circuit generates the other one of the low voltage signals and the high voltage signals when the light reflected from the corresponding information region has a high intensity.

3. The information processing system of claim 2, wherein the scannable document has a light background color, and further defines predetermined information regions that are selectably marked with a dark color, the intensity of the reflected light is low when the corresponding information region is marked, and the intensity of the reflected light is high when the corresponding information region is unmarked.

4. The information processing system of claim 1, wherein each gathering circuit comprises a light emitting diode and a phototransistor, the light emitting diode is capable of emitting the light and projecting the emitted light to the corresponding information region, the phototransistor is capable of receiving the reflected light, and selectively turns on based on the intensity of reflected light.

5. The information processing system of claim 4, wherein the phototransistor turns on when the intensity of reflected light is high.

6. The information processing system of claim 5, wherein the gathering circuit further comprises a first input terminal and a second input terminal, the first and the second input terminals are electrically coupled to a power supply, the anode of the light emitting diode is electrically coupled to the first input terminal, and the cathode is grounded; the collector of the phototransistor is electrically coupled to the second input terminal, the emitter of the phototransistor is grounded, a node connected between the second input terminal and the emitter of the phototransistor is capable of outputting the electrical signals.

7. The information processing system of claim 6, wherein the gathering circuit further comprises a first resistor and a second resistor, the first resistor is coupled between the first input terminal and the anode of the light emitting diode, the second resistor is coupled between the node and the second input terminal.

8. The information processing system of claim 1, wherein the result is a score, the processor compares the digital signals with a correct answer in digital signals format to generate the score.

9. The information processing system of claim 1, wherein the result is a ballot.

10. The information processing system of claim 1, wherein the scannable document is one of an answer sheet and a ballot.

11. The information processing system of claim 1, further comprising an output device for marking the scannable document with the result.

12. An information gathering apparatus for gathering information from a scannable document, the scannable document comprising a plurality of information regions, the information gathering apparatus comprising:
a plurality of gathering circuits corresponding to the plurality of information regions, each gathering circuit capable of emitting light, projecting the emitted light to the corresponding information region and receiving light reflected from the corresponding information region to generate electrical signals based on an intensity of reflected light.

13. The information gathering apparatus of claim 12, wherein the electronic signals includes a high voltage signal and a low voltage signal, the gathering circuit generates one of the high voltage signal and the low voltage when the intensity of the light reflected from the corresponding information region is low, and the gathering circuit generates the other one of the low voltage signals and the high voltage signals when the intensity of the light reflected from the corresponding information region is high.

14. The information gathering apparatus of claim 13, wherein the scannable document has a light background color, and further defines predetermined information regions that are selectably marked with a dark color, the intensity of the reflected light is low when the corresponding information region is marked, and the intensity of the reflected light is high when the corresponding information region is unmarked.

15. The information gathering apparatus of claim 14, wherein each gathering circuit comprises a light emitting diode and a phototransistor, the light emitting diode is capable of emitting light to the corresponding information region, and the phototransistor is capable of receiving the reflected light, and selectively turns on based on the intensity of reflected light.

16. The information gathering apparatus of claim 15, wherein the gathering circuit further comprises a first input terminal and a second input terminal, the first and the second input terminals are electrically coupled to power supplies, the anode of the light emitting diode is electrically coupled to the first input terminal, and the cathode is grounded; the collector of the phototransistor is electrically coupled to the second input terminal, the emitter of the phototransistor is grounded, a node connected between the second input terminal and the emitter of the phototransistor to output the electrical signals.

17. The information gathering apparatus of claim 16, wherein the gathering circuit further comprises a first resistor and a second resistor, the first resistor is coupled between the first input terminal and the anode of the light emitting diode, the second resistor is coupled between the node and the second input terminal.

18. The information gathering apparatus of claim 12, wherein the scannable document is one of an answer sheet and a ballot.
